(19) United States
(12) Patent Application Publication
(10) Pub. No.: US 2007/0250693 A1
(43) Pub. Date: Oct. 25, 2007

(54) Boot system and method thereof

(75) Inventors: Po-Jung Lin, Hsinchu City (TW); Shuei-Lin Chen, Hsinchu City (TW); Chia-Ming Hsuen, Hsinchu City (TW)

Correspondence Address: BACON & THOMAS, PLLC, 625 SLATERS LANE, FOURTH FLOOR, ALEXANDRIA, VA, 22314, US

(73) Assignee: ALTEK CORPORATION, Hsinchu City (TW)

(21) Appl. No.: 11/503,939

(22) Filed: Aug. 15, 2006

(30) Foreign Application Priority Data
Apr. 20, 2006 (TW) 095114070

(51) Int. Cl. G06F 15/177

(52) U.S. Cl. 713/1

(57) ABSTRACT

A boot system which uses a NAND flash is disclosed. The boot system is used for a digital camera, and it comprises a NAND flash, a flash control module, a processing module, and an IO bridge. The processing module includes a cache memory. When booting the digital camera, the cache memory reads a boot code from the NAND flash to the processing module for processing a booting operation.

### BACKGROUND OF THE INVENTION

1. Field of Invention

The present invention relates to a boot system for a digital camera, and more particularly, to a boot system which utilizes a NAND flash as storage media for a boot code.

2. Description of the Related Art

When performing a booting operation in the precedent technologies, ROM-based storage media such as a ROM or a NOR Flash are commonly used for storing a boot code. The processor is able to retrieve the boot code from the ROM or the NOR flash during the booting operation in a digital camera because both components posses random access feature. This boot method of utilizing the ROM or the NOR flash can be further distinguished as whether it locates in the exterior or the interior of the main control chip.

However, if the system is booted from the ROM or the NOR flash located within the interior of the main control chip such as a Mask ROM, one needs to tape-out the original content when it is used as a storage media for the boot code and re-establish the mask if the boot code contains an error or requires updating in order to modify the boot code stored in a Mask ROM. As a result, the methodology wastes time and incurs additional tape-out costs. On the other hand, if the system is booted by using the ROM or the NOR flash located external to the main control chip, no tape-out cost is needed, but it requires additional costs to install an external ROM or NOR flash, and it also incurs an extra cost to reserve a connecting bridge between the main control chip and the external ROM or the NOR flash. Thus, the manufacturing cost of the main control chip will be too costly for the digital camera.

Therefore, a new media for the storage of the boot code is required to solve the precedent technical problems.

### SUMMARY OF THE INVENTION

The objective of the present invention is to provide a boot system for a digital camera which utilizes a NAND flash memory as a storage media to store a boot code.

In order to achieve the aforementioned objectives, the present invention provides a boot system for a digital camera. The boot system of the present invention includes a NAND flash, a flash control module, a processing module and an IO bridge. The NAND flash comprises a boot code, a operation system code, and a permission code. The flash control module is electronically coupled with the NAND flash and is used to control the access of the NAND flash. The processing module comprises a cache memory. The cache memory is activated by the permission code, and it retrieves and stores the boot code temporarily to allow the processing module to boot the system.

The present invention also provides a boot method for a digital camera. In the duration of booting a digital camera, the effectiveness of the NAND flash is first detected to prevent bad sectors occurring in the NAND flash. Next, partial boot code is retrieved in accordance with the volume of the cache memory at different time intervals and stored temporarily. The processing module is then used to execute the boot code to boot the system, and the new boot code is retrieved repeatedly by the cache memory until the processing module completes all the boot procedures.

### BRIEF DESCRIPTION OF THE DRAWINGS

FIG. 1 is a structural block diagram of a boot system in accordance with the present invention.

FIG. 2 is a structural block diagram of boot system for a digital camera in accordance with the present invention.

FIG. 3 is a flow chart of a boot method for a digital camera in accordance with the present invention.

### DETAILED DESCRIPTION OF THE PREFERRED EMBODIMENT

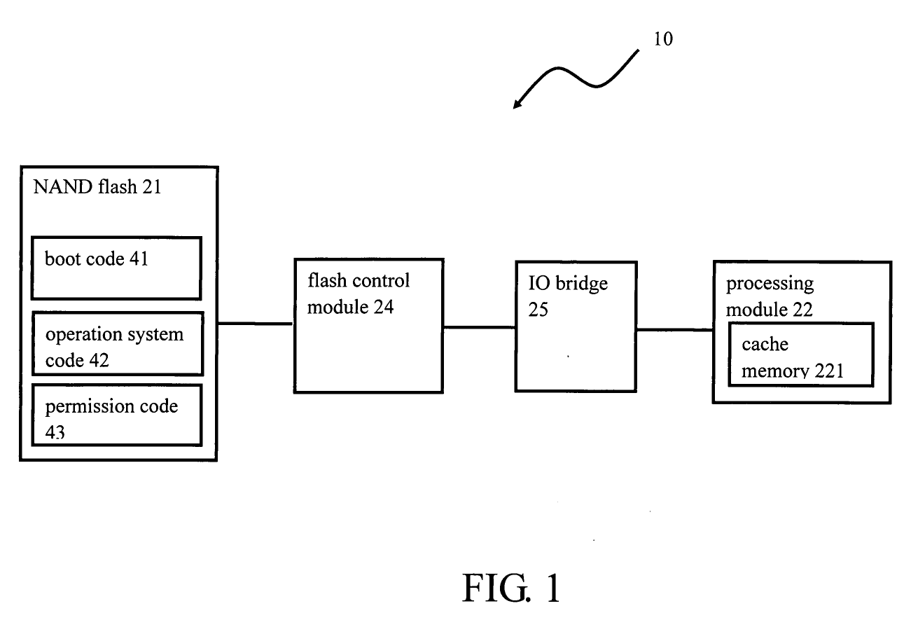

Please refer to FIG. 1, which shows a structural diagram of a boot system 10 for the present invention. In the preferred embodiment, the boot system 10 refers to a digital camera, but the present invention is not confined to this device alone.

As shown in FIG. 1, the boot system 10 comprises a NAND flash 21, a processing module 22, a flash control module 24 and an IO bridge 25.

The NAND flash 21 is able to offer the storage for a boot code 41, an operation system code 42 and a permission code 43. The NAND flash 21 is also electronically coupled with the flash control module 24. Therefore, the boot code 41, the operation system code 42 and the permission code 43 which are stored by the NAND flash 21 can be controlled and accessed via the flash control module 24.

Generally speaking, it is common for a NAND flash to contain bad blocks when they are manufactured; moreover, it is common that the memory modules have bit flip problems. Therefore, in the preferred embodiment of the present invention, the flash control module 24 consists of an automatic debugging function, which uses error-correcting code (ECC) to inspect and correct the bad blocks and bit flop contained in the NAND flash 21, and this is to ensure that the NAND flash is able to access the boot code 41, the operation system code 42 and the permission code 43 without any problems.

A NAND flash is commonly installed in digital camera systems for the storage of operation system code and other parameters, thus, the present invention makes use of the NAND flash 21 as a storage medium to store boot code 41 so that no additional storage medium cost is required as compared to the precedent technologies. Furthermore, when the boot code needs to be modified, it is more convenient to write internal data into the NAND flash, which avoids the tape-out cost and the manufacturing cost required in the Mask ROM of the precedent technologies.

On the other hand, NAND flash cannot perform speedy random access. In order to resolve the speed problem of accessing NAND flash 21, the present invention has incorporated a cache memory 221 into the processing module 22; this module is used to perform the digital camera's boot processes. Cache memory 221 can be used to store the boot code 41 temporarily, and it is used to speed up the process in which boot code 41 is retrieved when boot system 10 utilizes NAND flash 21 for booting.

In one preferred embodiment of the present invention, the cache memory 221 is activated by the permission code 43 of NAND flash 21. During the booting process of the digital camera, the present invention first activates cache memory 221 via the permission code 43. Next, partial boot code 41 will be retrieved into the cache memory in accordance to the size of cache memory 221 and is stored temporarily, and then the code is processed by processing module 22. When the processing module 22 completes the partial boot code 41, the cache memory 221 retrieves the remaining boot code 41 repeatedly until the boot code 41 is completely executed.

In addition, the present invention has an IO bridge 25, which is electronically coupled with and located in between processing module 22 and flash control module 24 to enable the data transmission between the processing module 22 and flash control module 24.

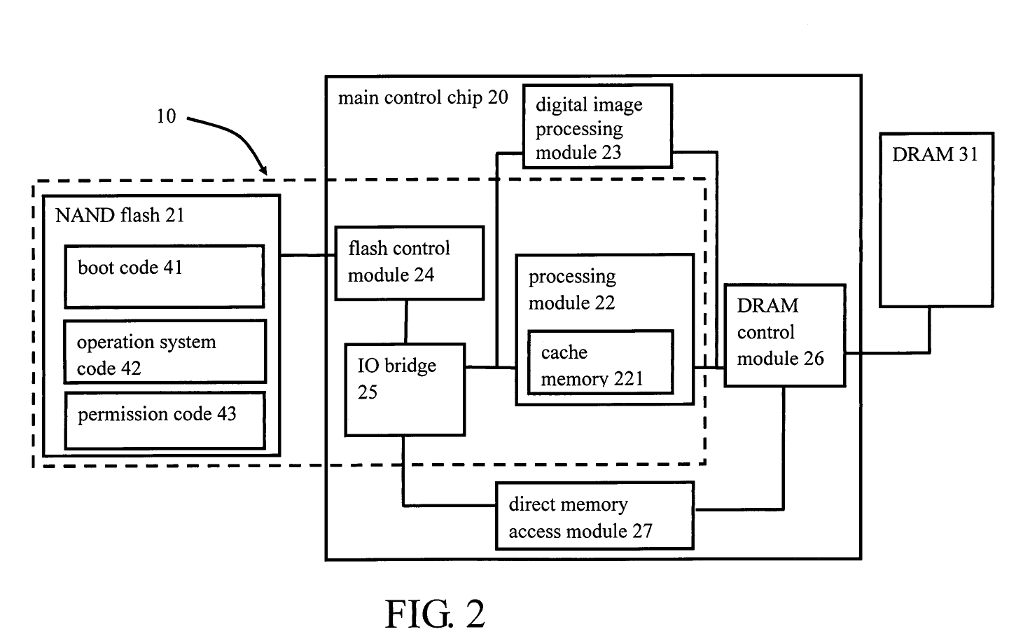

Next, please refer to FIG. 2, which shows a structural diagram of a boot system of a digital camera for the present invention. Depicted in FIG. 2 is the preferred embodiment of the present invention. The boot system 10 can be incorporated into a digital camera and integrated with other modules. However, the present invention is not confined to this structure; it can also be implemented in digital devices other than a digital camera, and still obtain the same effect as the present invention.

As shown in the embodiments of FIG. 2, the digital camera comprises a main control chip 20, a NAND flash 21 and a DRAM 31.

The main control chip 20 consists of a processing module 22, a digital image processing module 23, a flash control module 24, an IO bridge 25, a DRAM control module 26 and a direct memory access module 27.

Wherein, the NAND flash 21, the processing module 22, the flash control module 24 and the IO Bridge 25 are part of the boot system 10.

The digital image processing module 23 and processing module 22 are electronically coupled. After the processing module 22 completes the booting procedures through the use of boot code 41 obtained from the NAND flash 21, the processing module 22 and the digital processing module 23 can then execute the operation system code 42 which lies within the NAND flash 21. The DRAM control module 26 can be used to control the DRAM 31 to access the operation system code 42.

The operation system code 42 can enhance the processing speed of the processing module 22, and this enables the digital image processing module 23 to perform functions such as image shooting and browsing of a digital camera. However, the technology mentioned in this paragraph is not the core focus of the present invention, and will not be mentioned in detail.

The direct memory access module 27 is electronically coupled to the IO bridge 25 and to the DRAM control module 26. Instead of using the processing module 22 for data transfer, direct memory access module 27 can be used as a direct data bridge between the IO bridge 25 and the memory control module 26 to save system resource.

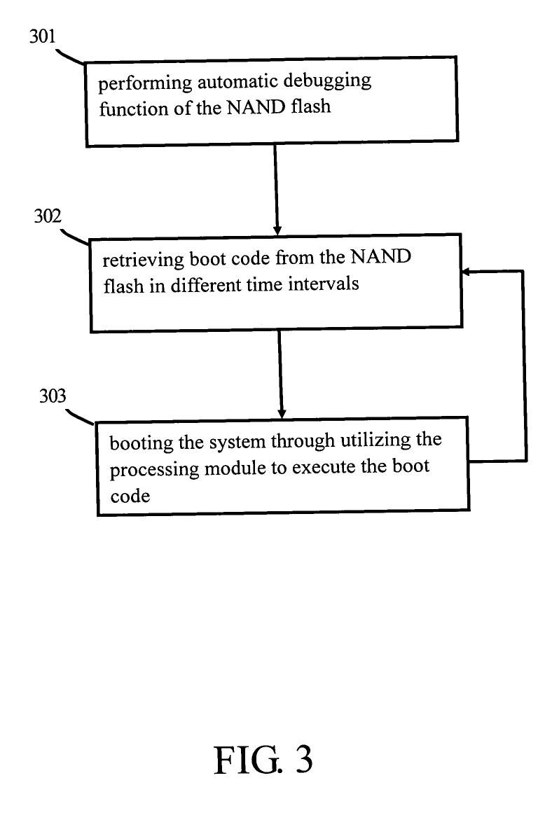

The present invention also provides a boot method for a digital camera. Please refer to FIG. 3 for a flow chart of a boot method for a digital camera in accordance with the present invention.

As depicted in FIG. 3, during the booting operation of a digital camera, the present invention first executes step 301, which performs automatic debugging function of the NAND flash 21. In order to ensure that the NAND flash 21 does not consist of wrong blocks (such as bad blocks or bit flops), the flash control module 24 will perform automatic debugging function before retrieving the boot code 41 from the NAND flash 21. In the present embodiment, the flash control module 24 reserves 512 bytes of memory for the debugging process, but the present invention is not restricted to 512 bytes.

When it is confirmed that the NAND flash 21 contains no wrong blocks or the error has been corrected, the present invention proceeds with step 302, which retrieves boot code 41 from the NAND flash 21 in different time intervals.

In the present embodiment, the NAND flash 21 preserves 64 bytes for the permission code 43 to activate the cache memory 221; however, the present invention is not restricted to 64 bytes.

After the activation of the cache memory 221, the cache memory 221 first confirms the reading address of the boot code 41, and then an appropriate size of boot code 41 will be read into the cache memory 221. This resolves the problem relating to the accessing speed of the NAND flash 21.

The reason for retrieving an appropriate size of boot code 41 to accommodating the storage volume of cache memory 221 is to prevent cache memory 221 from retrieving the entire boot code 41 at once, resulting in memory insufficiency. If this method is not introduced, memory insufficiency can be resolved by increasing additional cache memory 221; however, it will incur extra manufacturing cost. The present embodiment retrieves 2 KB of boot code 41, but the present invention is not restricted to 2 KB.

After partial boot code 41 is read into the cache memory 221, step 303 is initiated, which boots the system through utilizing the processing module 22 to execute the boot code 41.

The processing module 22 will execute the partial boot code 41 contained in the cache memory 221 at first. After the partial boot code 41 completes booting, cache memory 221 repeats the step 302. The cache memory retrieves new boot code 41 from the NAND flash 21 repeatedly to provide data to the processing module 22 until the booting procedures of the digital camera is totally completed. The digital camera can then utilize different modules, for example, the digital image processing module 23 to execute other functionalities such as image shooting and picture browsing.

Although the present invention has been explained in relation to its preferred embodiment, it is to be understood that many other possible modifications and variations can be made without departing from the principle and scope of the invention as hereinafter claimed.

What is claimed is:

1. A boot system for a digital camera, the boot system comprising: a NAND flash used for storing a boot code which is required for booting;
a flash control module electronically coupled with the NAND flash, used for controlling the NAND flash; and
a processing module electronically coupled with the flash control module, used for reading and executing the boot code from the NAND flash.

2. The boot system as claimed in claim 1, further comprising an IO bridge electronically coupled with the flash control module and the processing module, which is used for transferring the boot code from the flash control module to the processing module.

3. The boot system as claimed in claim 1, wherein the processing module further comprises a cache memory used for the temporary storage of the boot code.

4. The boot system as claimed in claim 1, wherein the NAND flash further stores an operation system code.

5. The boot system as claimed in claim 3, wherein the NAND flash further stores a permission code used to activate the cache memory.

6. The boot system as claimed in claim 1, wherein the NAND flash control module is able to inspect and correct memory sector errors within the NAND flash through an error-correcting code (ECC).

7. A boot method for a digital camera which utilizes a NAND flash to perform a booting operation, the method comprising the following steps:
performing an automatic debugging function of the NAND flash;
retrieving a boot code from the NAND flash at different time intervals; and
utilizing a processing module to execute the boot code to start the booting operation.

8. The boot method for the digital camera as claimed in claim 7, wherein the boot code is retrieved from the NAND flash at different time intervals by a cache memory.

9. The boot method for the digital camera as claimed in claim 8, further comprising the step of activating the cache memory.

10. The boot method for the digital camera as claimed in claim 8, further comprising the step of utilizing the cache memory to allocate an address of the boot code that is to be retrieved.

11. The boot method for the digital camera as claimed in claim 8, further comprising the step of temporarily storing the boot code at different time intervals to accommodate the volume of the cache memory.
